(19) United States
(12) Patent Application Publication
(10) Pub. No.: US 2013/0341177 A1
(43) Pub. Date: Dec. 26, 2013

(54) REGENERATIVE ADSORPTION DISTILLATION SYSTEM

(71) Applicants: Kim Choon NG, Singapore (SG); Kyaw Thu, Singapore (SG); Gary Amy, Jeddah (SA); Mohammed Chunggaze, Jeddah (SA); Tawfiq Al-Ghasham, Jeddah (SA)

(72) Inventors: Kim Choon NG, Singapore (SG); Kyaw Thu, Singapore (SG); Gary Amy, Jeddah (SA); Mohammed Chunggaze, Jeddah (SA); Tawfiq Al-Ghasham, Jeddah (SA)

(73) Assignees: KING ABDULLAH UNIVERSITY OF SCIENCE AND TECHNOLOGY, Thuwal (SA); NATIONAL UNIVERSITY OF SINGAPORE, (SG)

(21) Appl. No.: 14/003,965

(22) PCT Filed: Mar. 7, 2012
(86) PCT No.: PCT/SG2012/000076

§ 371 Date: Sep. 13, 2013

Related U.S. Application Data
(60) Provisional application No. 61/450,165, filed on Mar. 8, 2011.

(51) Int. Cl. B01D 3/00; C02F 1/04

(52) U.S. Cl. CPC B01D 3/00; C02F 1/043
USPC 203/10; 202/174; 203/41

(57) ABSTRACT

There is provided a regenerative adsorption distillation system comprising a train of distillation effects in fluid communication with each other. The train of distillation effects comprises at least one intermediate effect between the first and last distillation effects of the train, each effect comprising a vessel and a condensing tube for flow of a fluid therein. The system further comprises a pair of adsorption-desorption beds in vapour communication with the last effect and at least one intermediate effect, wherein the beds contain an adsorbent that adsorbs vapour from the last effect and transmits desorbed vapour into at least one of the intermediate effect.

### TECHNICAL FIELD

The present invention generally relates to a regenerative adsorption distillation system. The present invention also relates to a regenerative adsorption distillation method.

### BACKGROUND

The search for fresh or potable water remains a pressing concern throughout many regions of the world. Potable water is a basic and essential resource for all daily human activities, such as agricultural needs, industrial needs and for domestic consumption, and relate to the usage of potable water directly or indirectly.

The conventional supply of fresh water is from the natural water cycle, which is greatly influenced in many parts of the world by changes in climatic conditions that may lead to mal-distribution of local rainfall. Coupled with an increasing demand for water from the domestic, industrial and agricultural sectors, the gap between such demands and the amount of natural fresh water supply has widened in recent years. The World Health Organization (WHO) reported that at least one billion people are denied access to clean and fresh water, and more than 41% of the Earth's population lives in water-stressed areas. According to WHO and reports from the United Nations, the affected number of people that are denied access to clean and fresh water may climb to 3.5 billion or more by the year 2025. In particular, potable water shortage is severe in arid and semi-arid regions, such as the Arabian Gulf or the countries in the Gulf Cooperation Council (GCC). With increasing population growth in these GCC countries, the water shortage problem could reach crisis proportions by the year 2020.

To deal with the water shortage crisis, desalination has become a practical solution. Desalination is a process by which the dissolved salts in sea or brackish water are removed by the input of energy. In 2010, the total amount of potable water derived from such man-made processes exceed 61 million m³ per annum.

These processes are categorized into three groups, namely: (1) thermally-activated systems, which utilize thermal energy through evaporation and condensation processes; (2) pressure-activated systems, which utilize certain pressure higher than the osmotic pressure processes through semi-permeable membrane technology; and (3) chemically-activated desalination systems, which make use of chemical processes to produce potable water.

Of the above groups of processes, the Multi-Stage Flash (MSF), Multi-Effect Distillation (MED), Mechanical Vapor Compression (MVC) and Reverse Osmosis (RO) methods produce more than 80% of global desalination capacity. In particular, the MED systems are most energy efficient amongst the thermal desalination techniques, due to repeated boiling and condensation processes in multiple effects or stages.

In the recent decade, the adsorption desalination (AD) cycle, which is a thermal desalination technique, has emerged as a novel thermodynamic cycle that could utilize either low-temperature waste heat or renewable solar energy. To power a batch-operated AD cycle, heat input temperatures varying from 50° C. to 85° C. are sufficient to produce potable water from sea or brackish water. The adsorbent-adsorbate pair used in the AD cycle is the silica gel and water pair which is an inert and environmentally friendly adsorbent. During the AD cycle, desalting is performed as a simple and robust evaporative boiling that occurs in an evaporator chamber at sub-atmospheric pressure. An AD plant has almost no major moving parts except the water pumps and valves and thus, the specific energy (electricity) required to operate the AD cycle is inherently low, typically at 1.38 kWh/m³. Besides the low specific energy consumption, the evaporative processes of the AD cycle occur at low solution temperatures, typically from 5° C. to 20° C., and therefore fouling on the external surfaces of evaporator tubes can be significantly reduced.

Since the heat input temperatures of the AD cycle are low, the input heat source is deemed as free energy because it is obtained readily from waste heat or renewable sources. However, if such free energy is unused, it would be purged to the atmosphere, thereby creating wastage of free energy. Such free energy sources for desalination are akin to energy input from the sun to evaporate seawater from the ocean, which is essentially the natural water cycle. For natural water cycles, the free solar energy input is estimated to be 475 kWh/m³. Hence, in comparison with the engineered desalination processes, the use of free solar energy is highly inefficient since unused solar energy is lost to the atmosphere.

With respect to MED technologies, the presently available MED cycles of today are limited in the number of effects or stages by the condensing temperature which is dictated by the cooling media of the condenser. Furthermore, without external work input, the lowest temperature of the condenser is that of the seawater which is used for condensing the vapor of the last effect. The heat of condensation is also used for preheating of the incoming feed water. Accordingly, since the lowest temperature attained is that of the seawater, the heat of condensation generated is disadvantageously low. Hence, additional energy is also required to preheat the incoming feed water.

There is a known technique that combines the use of AD and MED cycles, wherein the vapor obtained from the evaporative processes of the AD cycle is fed into the first effect of the MED cycle. However, the number of effects of the MED cycle in this combination technique is also limited. In addition, this combination cycle can only be operated at high temperatures of about 200° C., adding to operational costs.

Therefore, there is a need to provide an efficient desalination technique that overcomes, or at least ameliorates, one or more of the disadvantages described above.

### SUMMARY

According to a first aspect, there is provided a regenerative adsorption distillation system comprising:

a train of distillation effects in fluid communication with each other and comprising at least one intermediate effect between the first and last distillation effects of the train, each effect comprising a vessel and a condensing tube for flow of a fluid therein; and

a pair of adsorption-desorption beds in vapour communication with the last effect and at least one intermediate effect, wherein the beds contain an adsorbent that adsorbs vapour from the last effect and transmits desorbed vapour into at least one intermediate effect.

According to a second aspect, there is provided a regenerative adsorption distillation method for producing condensate from a feed liquid phase stream, comprising the steps of:

(a) providing a train of distillation effects in fluid communication with each other and comprising at least one intermediate effect between the first and last distillation effects of the train, wherein each effect comprises a vessel and a condensing tube for flow of a fluid therein, wherein vapour present inside the condensing tube condenses to form a condensate while liquid present outside the condensing tube at least partially evaporates to form a vapour;

(b) passing vapour produced in the last effect to an adsorbent in a pair of adsorption-desorption beds; and

(c) passing the desorbed vapour from the adsorbent into at least one intermediate effect.

Advantageously, the disclosed system and method may result in a high water production yield while consuming less energy compared to conventional multi-effects distillation systems without the adsorption-desorption beds.

Advantageously, the introduction of desorbed vapour into the intermediate effect(s) may result in an increase in the number of effects that can be utilized in the system as well as allowing a number of the effects to work below ambient temperature. Due to the lowered temperature of the effects, the liquid streams that exit these effects may be used as cooling energy for other processes or in room air-conditioning.

### DEFINITIONS

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a regenerative adsorption distillation system will now be disclosed. The regenerative adsorption distillation system comprises a train of distillation effects in fluid communication with each other and comprising at least one intermediate effect between the first and last distillation effects of the train, each effect comprising a vessel and a condensing tube for flow of a fluid therein; and a pair of adsorption-desorption beds in vapour communication with the last effect and at least one intermediate effect, wherein the beds contain an adsorbent that adsorbs vapour from the last effect and transmits desorbed vapour into at least one intermediate effect.

Typically distillation effects are in series fluid flow with each adjacent distillation effect of said train.

The system may further comprise a vapour phase generation source configured to be in fluid communication with the train of distillation effects. The vapour phase generation source may be in fluid communication with the first effect. The vapour phase generation source may comprise an evaporator that feeds a vapour stream into the first effect and receives a liquid stream from at least one of the first effect, intermediate effect(s) and last effect.

The vapour phase generation source may be powered by a heat source such as waste heat or solar hot water, whereby the temperature of the heat source may be in the range selected from the group consisting of about 55° C. to about 150° C., about 55° C. to about 130° C., about 55° C. to about 110° C., about 55° C. to about 90° C., about 55° C. to about 85° C., about 55° C. to about 800° C., about 55° C. to about 70° C., about 55° C. to about 60° C., about 60° C. to about 150° C., about 70° C. to about 150° C., about 80° C. to about 150° C., about 85° C. to about 150° C., about 90° C. to about 150° C., about 110° C. to about 150° C. and about 130° C. to about 150° C. In one embodiment, the temperature of the heat source may be about 55° C. to about 85° C.

In the first effect, vapour phase from the vapour phase generation source enters the condensing tube and at least partially condenses therein to form a condensate liquid phase. Concurrently, in a counter-current flow configuration, liquid phase flowing into the first effect from the intermediate effect (second effect) as a falling film at least partially evaporates outside the condensing tubes to form a vapour phase outside of the condensing tubes. In this configuration, a feed liquid phase stream may be introduced into the last effect such that the flow of liquid phase and vapour phase between effects is in counter-current fluid flow. The latent heat from the condensation of the vapour inside the tubes causes the evaporation of the liquid outside the tubes. The vapour from the evaporation of the liquid may be combined with remaining vapour that did not condense inside the condensing tubes, if any, and introduced into the second effect and the above condensation-evaporation processes repeat in the second and subsequent effects.

The condensate liquid phase produced in the effects may be collected in a reservoir. The remaining liquid in the first effect (that is, concentrated feed liquid) which did not evaporate in the first effect flows to the vapour phase generation source to serve as a liquid source for the generation of vapour. The condensate liquid phase produced from the intermediate and last effects may either be collected in a reservoir or collected to pre-heat the incoming feed liquid phase stream.

Cooling energy may be extracted from the condensate liquid phase from the various effects using a heat exchanger and channeled to cool processes or in room air-conditioning. Cooling energy may also be extracted from the effects that are at a temperature below ambient temperature. For process cooling, relative high-temperature chilled water (temperature of about 10° C. to about 20° C.) can be used while for residential air-conditioning, relatively low-temperature chilled water (temperature of about 5° C. to about 10° C.) can be used. The cooling energy may be extracted from the lower temperature effects using a heat exchanger to supply the cooling energy. The concentrated feed liquid may pass through the heat exchanger prior to entering the next effect or bleed out from the effects.

In the intermediate effect, vapour that is rejected or desorbed from the adsorbent in the adsorption-desorption beds may be combined with the vapour from the preceding effect. The desorbed vapour may be introduced into the intermediate effect in vapour ducts controlled with valves. The operation of these valves is dependent on the temperature of the desorbed vapour, hence ensuring the effective recovery of the thermal energy from the vapour for evaporation in the effects. The vapour duct may be a single duct or multiple ducts. A single duct may be employed for simplicity whereas multiple ducts may be used to improve the water production rate from better reutilization of the desorbed vapour.

The temperature of the desorbed vapour may be substantially similar to or greater than the temperature of the intermediate effect. The temperature difference between the desorbed vapour and the intermediate effect (Tᵥₐₚₒᵤᵣ−T_{effect}) may be less than about 3° C. Hence, the temperature difference may be less than about 2.9° C., less than about 2.8° C., less than about 2.7° C., less than about 2.6° C., less than about 2.5° C., less than about 2.4° C., less than about 2.3° C., less than about 2.2° C., less than about 2.1° C., less than about 2.0° C., less than about 1.9° C., less than about 1.8° C., less than about 1.7° C., less than about 1.6° C., less than about 1.5° C., less than about 1.4° C., less than about 1.3° C., less than about 1.2° C., less than about 1.1° C., less than about 1.0° C., less than about 0.9° C., less than about 0.8° C., less than about 0.7° C., less than about 0.6° C., less than about 0.5° C., less than about 0.4° C., less than about 0.3° C., less than about 0.2° C. and less than about 0.1° C. The temperature difference may be 0° C.

The pressure of the desorbed vapour may also be substantially similar to that of the intermediate effect.

In an alternative embodiment, the flow of vapour phase and liquid phase between effects is in co-current fluid flow. Here, in addition to the vapour from the vapour phase generation source, the feed liquid phase stream is also fed to the first effect. As the vapour and liquid travels from the first effect to the last effect, the above condensation-evaporation processes and input of desorbed vapour into the intermediate effect(s) proceed as described above. After passing through the effects, the feed liquid phase stream becomes concentrated due to the removal of water. The concentrated feed liquid stream may be recycled back to the evaporator or may be discarded. If the temperature of this concentrated feed liquid stream is significantly below the ambient temperature, the concentrated feed liquid stream may be passed through a heat exchanger to extract the cooling energy from this stream.

The regenerative adsorption distillation system may comprise a vertically-stacked countered flow vapour and feed supply. In this configuration, the effect having the lowest stage temperature may be placed at the top-most position while the bottom-most effect has the highest temperature. The feed liquid phase stream may be supplied from the top-to-bottom of the stages, using gravity-assisted flow for the preheating of the feed liquid phase stream.

The regenerative adsorption distillation system may comprise a horizontal feed-forward, feed-backward or parallel-feed multi effect distillation cycle with the adsorption-desorption beds.

It is to be appreciated that the configuration of the regenerative adsorption distillation system and flow directions of the vapour and liquid are not particularly limited to the disclosed embodiments and can be of any configurations that can be envisaged by a person skilled in the art working within the boundaries of such systems.

The combination of the adsorption-desorption beds with the multiple distillation effects offers several advantages. Due to the input of desorbed vapour into the intermediate effect, a greater amount of condensate liquid phase may be produced in the intermediate effect, leading to an increase in the water production yield. In addition, the latent heat generated from the condensation of the vapour phase may be reused. In addition, the input of desorbed vapour into the intermediate effect may allow for more distillation effects to be used in this system as compared to a conventional multi-effect distillation system which does not have a pair of adsorption-desorption beds as part of its configuration and operation. Further, the additional effects used may be operated at a temperature below the ambient temperature, which is not possible in a conventional multi-effect distillation system. External heat that leaks into these low temperature effects may aid in the production of vapour in these effects. The low temperature evaporation and condensation of these effects operating below the ambient temperature may be maintained by the adsorption process of the adsorption-desorption beds.

The temperature in each effect may decrease progressively from the first effect to the last effect. The temperature of the last effect may be as low as the freezing point of the feed liquid phase stream, which may be about −1° C. The low temperature of the last effect may be due to the continued extraction of vapour from the last effect to the adsorption-desorption beds. The temperature of the last effect may be in the range of about −1° C. to about 120° C. while the temperature of the first effect is that of the vapour from the vapour phase generation source. Accordingly, the temperature of the last effect may be selected from the group consisting of about −1° C. to about 120° C., about −1° C. to about 100° C., about −1° C. to about 80° C., about −1° C. to about 60° C., about −1° C. to about 40° C., about −1° C. to about 20° C., about −1° C. to about 10° C., about −1° C. to about 5° C., about 5° C. to about 120° C., about 10° C. to about 120° C., about 20° C. to about 120° C., about 40° C. to about 120° C., about 60° C. to about 120° C., about 80° C. to about 120° C., about 100° C. to about 120° C., about 5° C. to about 20° C. and about 5° C. to about 10° C.

The train of distillation effects may comprise 3 to 25 distillation effects. Hence, the train of distillation effects may comprise 3, 4, 5, 6, 7, 8, 9, 10, 11, 12, 13, 14, 15, 16, 17, 18, 19, 20, 21, 22, 23, 24 or 25 effects.

The adsorption-desorption beds may comprise an adsorbent. The adsorbent may be a hydrophilic material with a pore surface not less than 200 m²/g or not less than 500 m²/g. The adsorbent may be selected from the group consisting of silicalite, silica gel, activated carbon, alumina, activated zeolite and silica-alumina.

The adsorption-desorption beds may be in thermal communication with a heat exchanger. The heat exchanger may comprise a cooling water supply and a heat source such as the heat source from the vapour phase generation source. In use, when one of the adsorption-desorption bed is exposed to vapour from the distillation module, in particular, from the last effect, the adsorbent adsorbs vapour into its pores due to the hydrophilic nature of the adsorbent. When the adsorbent is saturated, the adsorbent is then heated to cause the rejection or desorption of vapour from the pores of the adsorbent. As mentioned above, the rejected or desorbed vapour then goes into at least one of the intermediate effect(s). The adsorbent is then cooled to regenerate the adsorption ability of the adsorbent. Each bed is individually and independently heated and cooled such that when one bed is in the cooled stage, the other bed is in the heated stage. This may ensure a substantially constant supply of desorbed vapour to the intermediate effect (s) and may also aid in minimizing down-time associated with the heating and cooling of the beds.

The system may be used to produce potable water from a feed liquid phase stream such as seawater, treated seawater (ie that has had at least some of its original salt content removed), brackish water or grey water. Hence, the vapour produced in the system is water vapour and the condensate liquid phase is potable water.

Exemplary, non-limiting embodiments of a regenerative adsorption distillation method for producing condensate from a feed liquid phase stream will now be disclosed. The method comprises the steps of:

(a) providing a train of distillation effects in fluid communication with each other and comprising at least one intermediate effect between the first and last distillation effects of said train, wherein each effect comprises a vessel and a condensing tube for flow of a fluid therein, wherein vapour present inside said condensing tube condenses to form a condensate while liquid present outside said condensing tube at least partially evaporates to form a vapour;

(b) passing vapour produced in the last effect to an adsorbent in a pair of adsorption-desorption beds; and

(c) passing the desorbed vapour from said adsorbent into said at least one intermediate effect.

The method may comprise the step of providing a vapour phase generation source configured to be in fluid communication with the train of distillation effects. The method may comprise the step of feeding vapour from the vapour phase generation source such as an evaporator into the first effect.

The method may comprise the step of selecting the temperature of the heat source in the vapour phase generation source from the range selected from the group-consisting of about 55° C. to about 150° C., about 55° C. to about 130° C., about 55° C. to about 110° C., about 55° C. to about 90° C., about 55° C. to about 85° C., about 55° C. to about 800° C., about 55° C. to about 70° C., about 55° C. to about 60° C., about 60° C. to about 150° C., about 70° C. to about 150° C., about 80° C. to about 150° C., about 85° C. to about 150° C., about 90° C. to about 150° C., about 110° C. to about 150° C. and about 130° C. to about 150° C. In one embodiment, the temperature of the heat source may be about 55° C. to about 85° C.

The feed liquid phase stream may be fed into the last effect such that the feed liquid phase stream may at least partially evaporate to form a vapour. The non-evaporated liquid may flow into the preceding effect. Here, the liquid phase and vapour phase flow in a counter-current fluid flow.

In an alternative embodiment, the feed liquid phase stream may be fed into the first effect such that the feed liquid phase stream may at least partially evaporate to form a vapour. The non-evaporated liquid may flow into the next effect. Here, the liquid phase and vapour phase flow in co-current fluid flow.

The passing step (c) may comprise passing desorbed vapour to at least one intermediate effect which has a temperature that is substantially similar or lesser than that of the desorbed vapour. As mentioned above, the temperature difference (Tᵥₐₚₒᵤᵣ−T_{effect}) may be less than about 3° C. Hence, the temperature difference may be less than about 2.9° C., less than about 2.8° C., less than about 2.7° C., less than about 2.6° C., less than about 2.5° C., less than about 2.4° C., less than about 2.3° C., less than about 2.2° C., less than about 2.1° C., less than about 2.0° C., less than about 1.9° C., less than about 1.8° C., less than about 1.7° C., less than about 1.6° C., less than about 1.5° C., less than about 1.4° C., less than about 1.3° C., less than about 1.2° C., less than about 1.1° C., less than about 1.0° C., less than about 0.9° C., less than about 0.8° C., less than about 0.7° C., less than about 0.6° C., less than about 0.5° C., less than about 0.4° C., less than about 0.3° C., less than about 0.2° C. and less than about 0.1° C. The temperature difference may be 0° C.

The pressure of the desorbed vapour may also be substantially similar to that of the intermediate effect.

In each effect, the above condensation-evaporation processes take place. The method may comprise the step of collecting the condensate liquid phase from each effect in a reservoir.

The method may comprise the step of selecting the number of distillation effects from the group consisting of 3, 4, 5, 6, 7, 8, 9, 10, 11, 12, 13, 14, 15, 16, 17, 18, 19, 20, 21, 22, 23, 24 and 25 effects.

The method may comprise the step of selecting a hydrophilic material with a pore surface not less than 200 m²/g or not less than 500 m²/g as the adsorbent. The adsorbent may be selected from the group consisting of silicalite, silica gel, activated carbon, alumina, activated zeolite and silica-alumina.

As mentioned above, the adsorption-desorption beds may be in thermal communication with a heat exchanger. The method may comprise the step of alternatively heating or cooling the adsorption-desorption beds using the heat exchanger to thereby cause said adsorbent to reject vapour during heating and allow said adsorbent to adsorb vapour during cooling.

The method may be used to produce potable water from a feed liquid phase stream such as seawater, treated seawater (that is, seawater that has had at least some of the its original salt content removed), brackish water or grey water. Hence, the vapour produced in the system is water vapour and the condensate liquid phase is potable water.

The disclosed system and method may improve the water production yield by at least 1.5 times as compared to a conventional multi-effect distillation system without the adsorption-desorption beds. The water production yield may be improved by at least 1.6 times, at least 1.7 times, at least 1.8 times, at least 1.9 times, at least 2.0 times, at least 2.1 times, at least 2.2 times, at least 2.3 times, at least 2.4 times or at least 2.5 times.

The disclosed system and method may require lower specific (primary) energy consumption than a conventional multi-effect distillation system. Hence, the energy consumption of the disclosed system and method may be in the range selected from the group consisting of about 10 to about 20 kWh/m³, about 10 to about 19 kWh/m³, about 10 to about 18 kWh/111 about 10 to about 17 kWh/m³, about 10 to about 16 kWh/m³, about 10 to about 15 kWh/m³, about 10 to about 14 kWh/m³, about 10 to about 13 kWh/m³, about 10 to about 12 kWh/m³, about 10 to about 11 kWh/m³, about 11 to about 20 kWh/m³, about 12 to about 20 kWh/m³, about 13 to about 20 kWh/m³, about 14 to about 20 kWh/m³, about 15 to about 20 kWh/m³, about 16 to about 20 kWh/m³, about 17 to about 20 kWh/m³, about 18 to about 20 kWh/m³, about 19 to about 20 kWh/m³ and about 11 to about 13 kWh/m³. In one embodiment, the energy consumption is about 12 kWh/m³ while that of a conventional system is about 22 kWh/m³.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram of the regenerative adsorption distillation system according to one embodiment.

FIG. 2a is a schematic diagram of the cross-section of an intermediate effect in the disclosed regenerative adsorption distillation system. FIG. 2b is an expanded view of the condensing tube within the intermediate effect of FIG. 2a.

FIG. 3 is a graph showing the simulated temperature-time profiles of the effects in the disclosed regenerative adsorption distillation system. Here, eight effects are used in the simulation.

FIG. 4 is a graph showing the simulated transient water production rate of the disclosed regenerative adsorption distillation system.

FIG. 5 is a graph showing the simulated transient water production rate of the disclosed regenerative adsorption distillation system with eight stages as compared to a conventional multi-effect distillation system with five stages.

### DETAILED DESCRIPTION OF DRAWINGS

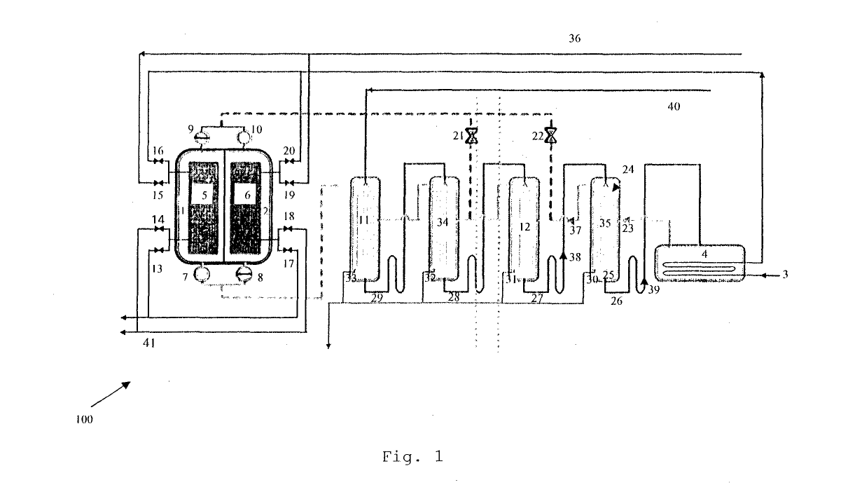

Referring to FIG. 1, there is shown a schematic diagram of the disclosed regenerative adsorption distillation system 100 according to one embodiment in which the horizontal backward-feed multi-effect distillation cycle is incorporated with a two-bed adsorption-desorption cycle.

The regenerative adsorption distillation system (100) comprises a train of distillation effects in fluid communication with each other. Here, four distillation effects (35,12,34,11) are shown in which there are two intermediate effects (12,34) between the first effect (35) and last effect (11). Each effect (35,12,34,11) comprises a vessel and a condensing tube (24) for flow of a fluid therein.

The regenerative adsorption distillation system (100) further comprises a pair of adsorption-desorption beds (1,2) in vapour communication with the last effect (11) and intermediate effects (12,34). The beds (1,2) contain an adsorbent such as silica gel (5,6) that adsorbs vapour from the last effect (11) and transmits desorbed vapour into the intermediate effects (34,12). The silica gel (5,6) has a surface area more than 500 m²/g with higher equilibrium uptake of adsorbate such as water vapor.

The regenerative adsorption distillation system (100) further comprises a vapour phase generation source in the form of an evaporator (4), which is heated by heat source (3) such as waste heat or solar hot water. The evaporator (4) produces vapour which is fed into the first effect (35) as shown by the arrow (23) while taking concentrated seawater from the first effect (35) as shown by the arrow (39).

The beds (1,2) may each operate in series or parallel with the heat source (3). When the beds (1,2) are operated in series, the hot water is first fed to the evaporator (4) prior to feeding it to the beds (1,2).

In a given batch-operated half-cycle, the beds (1,2) are linked to the last effect (11) via vapour valves (7,8) to draw vapour from the last effect (11). The beds (1,2) are linked to the intermediate effects (34,12) via vapour valves (9,10,21,22) to transmit desorbed vapour from the beds (1,2) to the intermediate effects (34,12).

The coolant valves (13,14,15,16,17,18,19,20) connect the heat exchangers containing the silica gels (5,6) in the beds (1,2) to either the cooling water supply (36) or the heat source (3) depending on the mode of operation such as adsorption and desorption. The heat source exits the system (100) from heat source outlet (41). The opening and closing of the coolant valves (13,14,15,16,17,18,19,20) are timed accordingly to the two timing intervals, namely, the switching and the half-cycle intervals. Further, the vapour valves (21,22) that distribute the vapour to the pre-selected intermediate effects (34,12) are always dictated by the positive temperature differential between the desorber bed (1,2) and the condensing (vapor) temperature of the intermediate effects (34,12). The vapor distribution may be individual or simultaneous, depending on the differential temperatures and the effect pressures.

The feed liquid phase stream such as seawater feed (40) is fed into the last effect (11).

The heat transfer mode in the evaporator (4) is largely controlled by the pool-boiling phenomenon, namely the Rosenhow correlation and this occurs fairly close to the temperature of the heat source (3). The generated vapour moves to the first effect (35) as shown by the arrow (23) where the vapour enters the condensing tube (24) and condenses on the inner tube walls, whilst the heat of condensation sets off an evaporation effect on the outer tube walls where a film of seawater flows down from the top of the first effect (35). The positive temperature gradient across the falling water film promotes surface evaporation of vapor where the system saturation pressure is slightly lower in the chambers. The excess liquid on the outside of the tubes is also preheated in the downward flow, giving rise to a slight increase in the liquid temperature as it transverse down to be collected at the bottom chamber (25) of the first effect (35).

The vapour produced from the first effect (35) passes into the next intermediate effect (12) as shown by the arrow (37) while the concentrated seawater from the intermediate effect (12) flows into the first effect (35) as shown by the arrow (38) in a counter-current configuration. This is repeated in the other effects (intermediate effect (34) and last effect (11)).

The pressure difference between the various effects is balanced automatically using U-tube devices (26,27,28,29).

The condensate liquid phase is collected at the bottom of the condensing chambers (30,31,32,33) and extraction of condensate liquid phase from the chambers can be performed using a pump. Another possible means of extracting the condensate liquid phase is by using a 10 m U-tube (not shown in FIG. 1).

In the regenerative adsorption distillation system (100), the effects (11,34,12,35) operate at two clusters of operating temperature level i.e., temperature (i) higher and (ii) lower than the ambient temperature. Intermediate effect (34) and last effect (11) are operating at sub atmospheric temperatures (lower than 30° C.) while intermediate effect (12) and first effect (35) are operating at higher temperatures. These low temperature effects (11,34) result from the combination of the adsorption-desorption cycle at the end of the lowest temperature effect (11) from which the beds (1,2) adsorb water vapor to the surface of the silica gel (5,6). The operating temperature in the last effect 11 of the system 100 could be as low as 5° C.

In another configuration of supplying the heat source (3) to the system (100), the beds (1,2) precedes the evaporator (4) in receiving the hot water. In such a configuration (not shown in FIG. 1), the pressure of the evaporator (4) could be fluctuating in tandem with the batch-operated beds (1,2). Although this is a feasible operating sequence of the system (100), it is less favored due to the oscillating pressures in the effects (11,34,12,35).

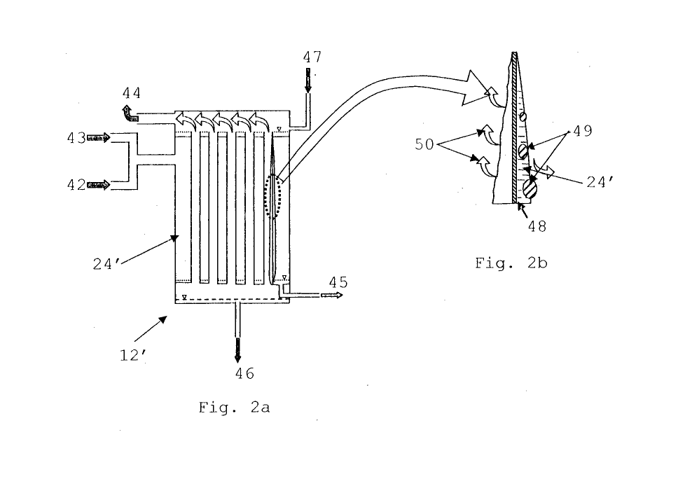

Referring to FIG. 2a, there is shown a schematic diagram of the cross-section of an intermediate effect (12′) in the regenerative adsorption distillation system (100) of FIG. 1. Like reference numerals are used to represent like features, but with an additional prime (′) symbol.

In this intermediate effect (12′), vapour from the first effect (42) as well as desorbed vapour from the beds (43) enter the condensing tube (24′). Here, the combined vapour condenses to form a condensate liquid phase (45) while releasing its latent heat of condensation to a falling film of seawater (47) outside the condensing tube (24′). The seawater (47) is fed into the top of the intermediate effect (12′) and flows down the intermediate effect (12′) by gravity. The seawater (47) heats up and evaporates to form water vapour (44) that travels to the next effect (intermediate effect (34) of FIG. 1). Any remaining seawater (47) is collected and fed to the first effect.

FIG. 2b is an expanded view showing the condensation and evaporation processes that take place at the wall (48) of the condensing tube (24′). As seen in FIG. 2b, the vapour phase condenses inside the condensing tube (24′) to form water vapour molecules (49) while the liquid phase outside the condensing tube (24′) evaporates to form a vapour as depicted by the arrows (50).

### EXAMPLES

Non-limiting examples of the invention will be further described in greater detail by reference to specific Examples, which should not be construed as in any way limiting the scope of the invention.

### Example 1

A simulation of the transient temperature-time profile in the regenerative adsorption distillation system was carried out on the IMSL platform based on the parameters shown in Table 1 below. Eight integrally-linked effects were simulated, four of which were able to operate below ambient temperatures. These four effects could exploit the heat leaks from the external environment to increase the water production of the system. When the temperature of the heat source was set at 85° C. and the ambient temperature was set at 30° C., it can be seen that a conventional multi-effect distillation (without complicated heat recovery schemes) could give at best three effects whilst the disclosed system could easily yield eight effects of water production.

TABLE 1

| | |
|---|---|
| Heat source temperature: | 85° C. |
| Heat source flow rate: | 48LPM |
| Cooling water temperature: | 30° C. |
| Cooling water flow rate: | 48LPM |
| Mass of silica gel: | 144 kg |
| Number of beds: | 4 |
| Number of effects: | 8 |
| Feed seawater temperature: | 30° C. |
| Seawater flow rate: | 10LPM |
| Concentration of seawater at | 35000 ppm |
| inlet: | |
| Area of brine heater (TBT): | 3 m² |
| Area of each effect or stage: | 2.4 m² |
| Tube materials: | Cuprous Nickel |

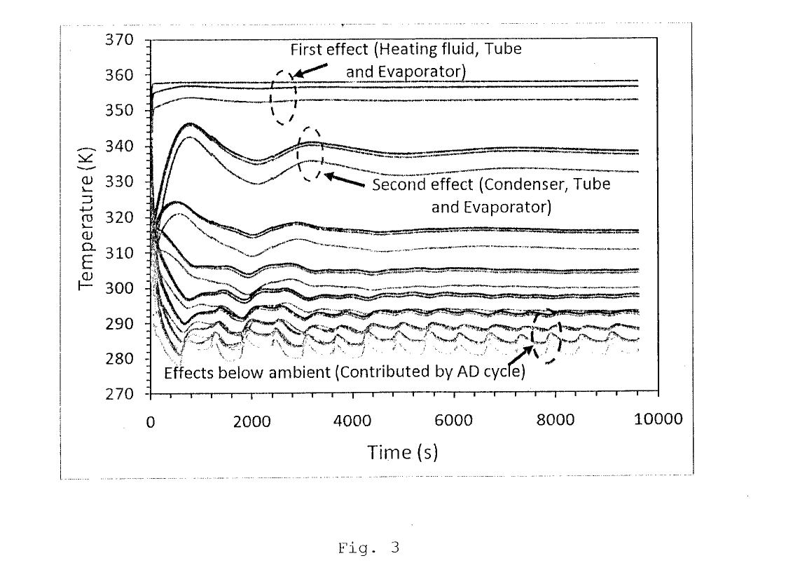

FIG. 3 depicts the performance of the disclosed regenerative adsorption distillation system obtained in this simulated example. The temperature profiles of the system with eight effects highlighted the effects operating above and below the ambient temperature, which was set at about 303K. The evaporation and condensation processes in the first three effects were dominated by the heat source temperature in the first effect whilst these in the later effects were influenced by the adsorption phenomenon that operated in a batch mode of adsorption and desorption, incurring the temperature fluctuation. As shown by the lowest circle in FIG. 3, four effects could be operated below the ambient temperature, which is possible due to the contribution of the adsorption desalination (AD) cycle.

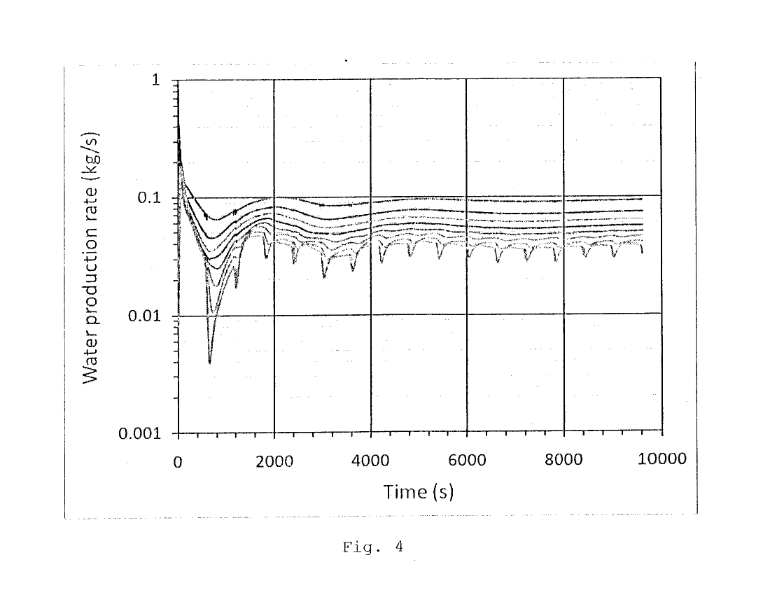

FIG. 4 shows the water production rate of the simulated regenerative adsorption distillation system. The same kind of fluctuation in the water production rate at lower temperature effects was observed, thus increasing the overall water production rate of the disclosed system. The total water production yield from the disclosed system was obtained by summing up the various water production rates. Here, the water production yield of the disclosed system is 0.4 kg/s ((1.44 m3/h) while that for MED is 0.22 kg/s (0.792 m3/h).

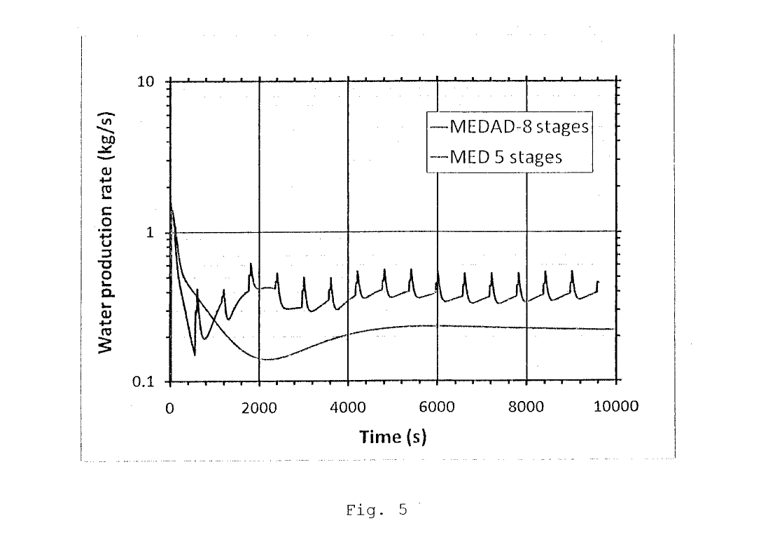

FIG. 5 is a graph showing the simulated transient water production rate of the disclosed regenerative adsorption distillation system with eight stages (labeled as “MEDAD-8 stages”) as compared to a conventional multi-effect distillation system with five stages (labeled as “MED 5 stages”). As shown, the water production rate of the disclosed system is greatly increased as compared to that of a conventional multi-effect distillation system.

### APPLICATIONS

Advantageously, the disclosed process provides an efficient desalination technique which symbiotically integrates an adsorption desalination (AD) cycle with a multi-effect desalination (MED) cycle.

Specifically, the advantages of an AD cycle whereby waste heat can be utilized to generate water vapor are advantageously exploited in the invention disclosed herein to increase the number of effects of the MED cycle.

Advantageously, the water vapor generated from the AD cycle enables the effects or stages of the MED cycle to operate below ambient temperatures. Further, as a consequence of the low evaporative temperatures of the stages, scaling and fouling in the tubes are advantageously prevented.

Advantageously, the combination of AD and MED cycles as disclosed herein improves water production yield by more than 1.7 times of conventional MED cycles, thereby lowering the specific energy consumption of the disclosed process to only about 12 kWh/m³. Furthermore, cooling energy is produced and may be recycled back to the disclosed process or may be used for other industrial or commercial needs.

Advantageously, the disclosed system has few moving parts and thus, has lower maintenance costs as compared with other conventional desalination methods.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A regenerative adsorption distillation system comprising:
a train of distillation effects in fluid communication with each other and comprising at least one intermediate effect between the first and last distillation effects of said train, each effect comprising a vessel and a condensing tube for flow of a fluid therein; and
a pair of adsorption-desorption beds in vapour communication with said last effect and said at least one intermediate effect, wherein said beds contain an adsorbent that adsorbs vapour from the last effect and transmits desorbed vapour into said at least one intermediate effect.

2. The system of claim 1, comprising a vapour phase generation source configured to be in fluid communication with said train of distillation effects.

3. The system of claim 2, wherein said vapour phase generation source comprises an evaporator that feeds a vapour stream into said first effect and receives a liquid stream from at least one of the first effect, intermediate effects and last effect.

4. The system of claim 3, wherein the temperature in each effect decreases progressively from the first effect to the last effect.

5. The system of claim 4, wherein a feed liquid phase stream is introduced into the last effect and the flow of vapour phase and liquid phase between effects is in counter-current fluid flow.

6. The system of claim 4, feed liquid phase stream is introduced into the first effect and the flow of vapour phase and liquid phase between effects is co-current fluid flow.

7. The system of claim 6, wherein the vapour phase condenses inside said condensing tubes to form a condensate liquid phase.

8. The system of claim 7, wherein the latent heat released from the condensation of the vapour phase evaporates the liquid phase outside of said condensing tubes to form a vapour phase outside of said condensing tubes.

9. The system of claim 7, comprising a reservoir for collecting the condensate from each effect.

10. The system of claim 9, wherein the temperature of said desorbed vapour is substantially similar to or greater than the temperature of said intermediate effect.

11. The system of claim 10, the number of said distillation effects is selected from the group consisting of 3, 4, 5, 6, 7, 8, 9, 10, 11, 12, 13, 14, 15, 16, 17, 18, 19, 20, 21, 22, 23, 24 and 25 effects.

12. The system of claim 11, wherein the operating temperature of said vapour phase generation source is in the range of 55° C. to 150° C.

13. The system of claim 12, wherein the temperature of the last effect is in the range of −1° C. to 20° C.

14. The system of claim 13, wherein the adsorbent is a hydrophilic material with a pore surface not less than 200 m²/g.

15. The system of claim 14, wherein said adsorbent is selected from the group consisting of silicalite, silica gel, activated carbon, alumina, activated zeolite and silica-alumina.

16. The system of claim 15, comprising a heat exchanger in thermal communication with said adsorption-desorption beds, wherein heat is applied to cause said adsorbent to reject vapour and wherein heat is removed to allow said adsorbent to adsorb vapour.

17. The system of claim 16, wherein said feed liquid phase stream is selected from the group consisting of seawater, seawater that has had at least some of its original salt content removed, brackish water and grey water.

18. The system of claim 17, wherein said vapour is water vapour and said condensate is water.

19. A regenerative adsorption distillation method for producing condensate from a feed liquid phase stream, comprising the steps of
(a) providing a train of distillation effects in fluid communication with each other and comprising at least one intermediate effect between the first and last distillation effects of said train, wherein each effect comprises a vessel and a condensing tube for flow of a fluid therein, wherein vapour present inside said condensing tube condenses to form a condensate while liquid present outside said condensing tube at least partially evaporates to form a vapour;
(b) passing vapour produced in the last effect to an adsorbent in a pair of adsorption-desorption beds; and
(c) passing the desorbed vapour from said adsorbent into said at least one intermediate effect.

20. The method of claim 19, comprising the steps of feeding said feed liquid phase stream into the last effect, said feed liquid phase stream at least partially evaporating to form a vapour and flowing the non-evaporated liquid into the preceding effect.

21. The method of claim 19, comprising the steps of feeding said feed liquid phase stream into the first effect, said feed liquid phase stream at least partially evaporating to form a vapour and flowing the non-evaporated liquid into the next effect.

22. The method of claim 21, comprising the step of providing a vapour phase generation source configured to be in fluid communication with said train of distillation effects.

23. The method of claim 22, comprising the step of feeding vapour from said vapour phase generation source into the first effect.

24. The method of claim 23, comprising the step of collecting the condensate from each effect in a reservoir.

25. The method of claim 24, wherein in step (c), the desorbed vapour is passed to said at least one intermediate effect which has a temperature that is substantially similar or lesser than that of the desorbed vapour.

26. The method of claim 25, comprising the step of selecting the number of distillation effects from the group consisting of 3, 4, 5, 6, 7, 8, 9, 10, 11, 12, 13, 14, 15, 16, 17, 18, 19, 20, 21, 22, 23, 24 and 25 effects.

27. The method of claim 23, comprising the step of selecting the operating temperature of said vapour phase generation source is in the range of 55° C. to 150° C.

28. The method of any claim 27, comprising the step of selecting said adsorbent as a hydrophilic material with a pore surface not less than 200 m²/g.

29. The method of claim 28, wherein said adsorbent is selected from the group consisting of silicalite, silica gel, activated carbon, alumina, activated zeolite and silica-alumina.

30. The method of claim 29, comprising the step of alternatively heating or cooling said adsorption-desorption beds using a heat exchanger in thermal communication with said beds to thereby cause said adsorbent to reject vapour during heating and allow said adsorbent to adsorb vapour during cooling.

31. The method of claim 30, wherein said feed liquid phase stream is seawater, seawater with at least some of its original salt content removed, brackish or grey water, said vapour is water vapour and said condensate is water.
